(19) United States
(12) Patent Application Publication
(10) Pub. No.: US 2014/0256367 A1
(43) Pub. Date: Sep. 11, 2014

(54) SHORT MESSAGE SERVICE PROMPTING SYSTEM AND METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventor: XIAN QIAN, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/966,250

(22) Filed: Aug. 13, 2013

(30) Foreign Application Priority Data
Mar. 11, 2013 (CN) 2013100757888

(51) Int. Cl. H04W 4/14

(52) U.S. Cl. CPC H04W 4/14
USPC 455/466

(57) ABSTRACT

A short message service prompting system and a short message service prompting method adapted for a mobile phone are disclosed. The mobile phone stores a relationship between each service provider and network IDs. The method includes steps: displaying a user interface, wherein the user interface comprises a receiver; receiving a receiver in the user interface; and acquiring phone numbers of a sender and the receiver and determining whether or not both the sender and the receiver are from the same service provider according to the relationship. The method further includes step: generating a short message service prompt and displaying the prompt when both the sender and the receiver are from different service providers or from the same service provider. Therefore, the sender may make a choice whether or not to send the short message according to the displayed prompt.

### BACKGROUND

1. Technical Field

The disclosure relates to wireless communication technology and, more particularly, to a short message service prompting system and a short message service prompting method adapted for a mobile phone.

2. Description of Related Art

People often use the mobile phones to send short messages. When a person (a sender) sends a short message to a receiver, if the sender and the receiver are from different service providers or the same service provider, the fee of the short message between different service providers is different from the fee of the short message from the same service provider. However, people do not know the service provider the receiver belongs to, which may result in fee loss. For example, when the sender and the receiver are from China Mobile, the fee of a short message between the sender and the receiver is 0.1 Yuan; and when the sender is from China Mobile and the receiver is from China Unicom, the fee of a short message is 0.15 Yuan between the sender and the receiver.

Therefore, what is needed is a short message service prompting system to overcome the described shortcoming.

### BRIEF DESCRIPTION OF THE DRAWINGS

FIG. 1 is a block diagram of a mobile phone including a short message service prompting system in accordance with an exemplary embodiment.

FIG. 2 is a block diagram of the short message service prompting system of the mobile phone of FIG. 1.

FIG. 3 is a flowchart of a short message service prompting method adapted for the mobile phone of FIG. 1.

FIG. 4 is a schematic view of a short message editing interface of the mobile phone of FIG. 1.

### DETAILED DESCRIPTION

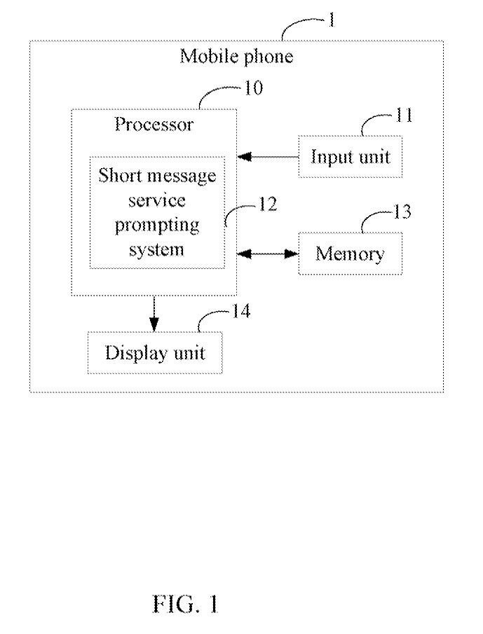

FIG. 1 is a block diagram of a mobile phone including a short message service prompting system in accordance with an exemplary embodiment. The mobile phone 1 includes an input unit 11, a processor 12, a memory 13, and a display unit 14. The input unit 11 generates input signals in response to user input. The processor 12 controls the mobile phone 1 to work and perform the short message service prompting system 10. The display unit 14 displays information.

A SIM card inserted into the mobile phone 1 is assigned a phone number composed of a predetermined number of digits, for example, eleven digits, and the SIM card and the phone number are from a service provider, such as China Mobile, China Unicom, or China Telecom. Each phone number is defined in accordance with a standard encoding rule. For example, the encoding rule defines that the first three digits of the phone number, i.e., from the first digit to the third digit, represents a network ID of a service provider, the middle four digits of the phone number, i.e., from the fourth digit to the seventh digit, represents a code number, and the last four digits of the phone number, i.e., from the eighth digit to the eleventh digit, represents a user number.

The service providers, such as China Mobile, China Unicom, and China Telecom, are assigned different network IDs. For example, China Mobile includes a first type of network IDs, such as 133, 153, 180, and 189, China Unicom includes a second type of network IDs, such as 131, 145, 155, and 186, and China Telecom includes a third type of network IDs, such as 135, 147, 150, 182. The memory 13 stores a relationship between each service provider and the network IDs, and a phonebook including a number of contacts. Each contact includes a user name and a phone number.

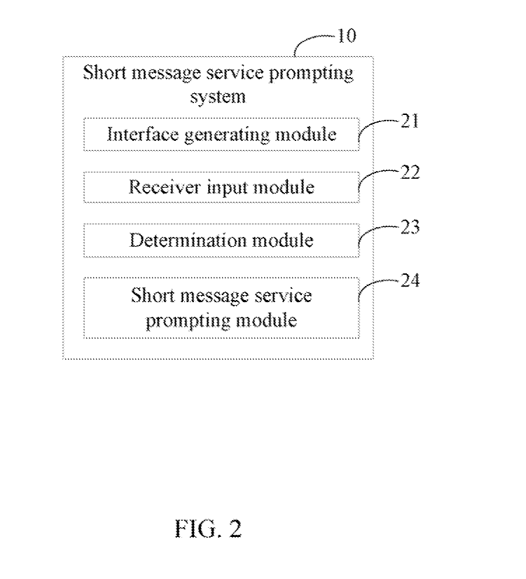

As shown in FIG. 2, the short message service prompting system 10 further includes an interface generating module 21, a receiver input module 22, a determination module 23, and a short message service prompting module 24, all of which are collection of software instructions and executed by the processor 12.

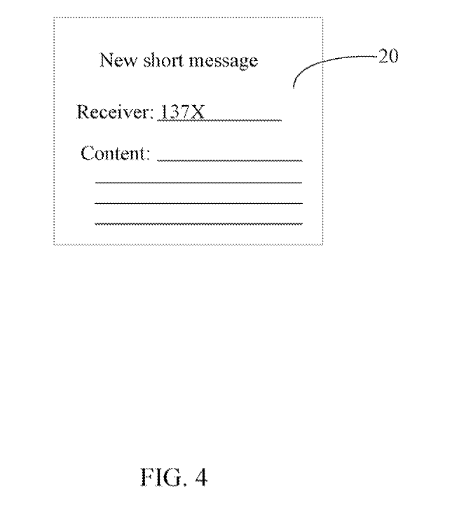

For a simple description, a user who receives a short message is defined as a receiver. The interface generating module 120 controls the display unit 14 to display a user interface named as a short message editing interface in response to user input from the input unit 11. As shown in FIG. 4, the short message editing interface 20 shows a receiver and content of a new short message. The receiver input module 22 obtains the receiver shown in the short message editing interface 20 in response to user input from the input unit 11. The receiver is represented by a phone number or is represented by a user name from the phonebook.

For a simple description, a user of the mobile phone 1 is defined as a sender. The determination module 23 acquires a phone number associated with the sender from the SIM card inserted into the mobile phone 1 and a phone number associated with the receiver, and determines whether or not both the sender and the receiver are from the same service provider according to the relationship between each service provider and the network IDs. For example, the determination module 23 respectively acquires a preset number of digits associated with the sender and the receiver, and determines whether or not both the preset number of digits associated with the sender and the receiver are from the same service provider. In the embodiment, the preset number of digits is the first three digits of the phone number.

When both the sender and the receiver are from different service providers, the short message service prompting module 24 generates a short message service prompt containing that the sender and the receiver are from different service providers, and controls the display unit 14 to display the short message service prompt. For example, the first three digits of the phone number associated with the sender is “133”, and the first three digits of the phone number associated with the receiver is “137”, the sender is from China Telecom, and the receiver is from China Mobile according to the stored relationship, the display unit 14 displays a short message service prompt “Dear user, the receiver is from a different service provider, if you send the short message, you will get a high fee, please attention”. Therefore, the sender may make a choice whether or not to send the short message according to the prompt on the display unit 14.

When both the sender and the receiver are from the same service provider, the short message service prompting module 24 generates a short message service prompt containing that the sender and the receiver are from the same service provider, and controls the display unit 14 to display the short message service prompt. For example, the first three digits of the phone number associated with the sender is “135”, and the first three digits of the phone number associated with the receiver is “137”, and both the sender and the receiver are from China Mobile according to the stored relationship, the display unit 14 displays a short message service prompt “Dear user, the receiver is from the same service provider, if you send the short message, you will pay a small fee”. Therefore, the sender may make a choice whether or not to send the short message according to the prompt on the display unit 14.

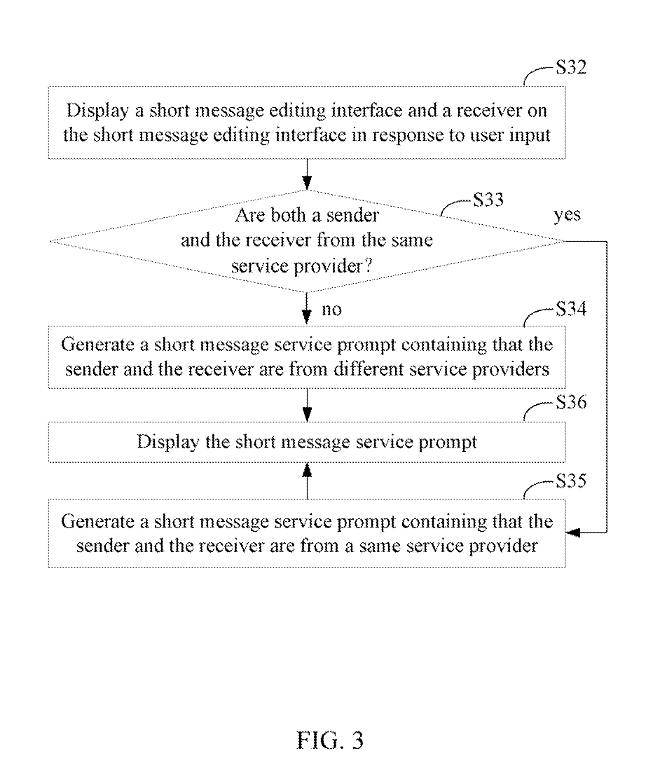

FIG. 3 is a flowchart of a short message service prompting method adapted for the mobile phone of FIG. 1. In step S32, the interface generating module 120 controls the display unit 14 to display a short message editing interface in response to user input from the input unit 11 and the receiver input module 22 obtains the receiver shown in the short message editing interface 20 in response to user input from the input unit 11.

In step S33, the determination module 23 acquires a phone number associated with the sender from the SIM card inserted into the mobile phone 1 and a phone number associated with the receiver, and determines whether or not both the sender and the receiver are from the same service provider according to the relationship between each service provider and the network IDs.

In step S34, when both the sender and the receiver are from different service providers, the short message service prompting module 24 generates a short message service prompt containing that the sender and the receiver are from different service providers, and goes to step S36.

In step S35, when both the sender and the receiver are from the same service provider, the short message service prompting module 24 generates a short message service prompt containing that the sender and the receiver are from the same service provider, and in step S36, the short message service prompting module 24 controls the display unit 14 to display the short message service prompt.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A short message service prompting system for a mobile phone, wherein the mobile phone comprises a display unit and stores a relationship between each service provider and network IDs, the short message service prompting system comprising:
one or more processors; and
a plurality of modules to be executed by the one or more processors, the modules comprising:
an interface generating module to controls the display unit to display a short message editing interface in response to user input, wherein the short message editing interface comprises a receiver;
a receiver input module to receive a receiver in the short message editing interface in response to user input;
a determination module to acquire a phone number of a sender of the mobile phone and a phone number of the receiver, and determines whether or not both the sender and the receiver are from the same service provider according to the relationship between each service provider and network IDs; and
a short message service prompting module to generate a short message service prompt and control the display unit to display the short message service prompt when both the sender and the receiver are from different service providers or from the same service provider.

2. The short message service prompting system of claim 1, wherein the receiver is represented by a series of digits or a user name.

3. The short message service prompting system of claim 1, wherein the determination module is respectively configured to acquire a preset number of digits of the phone number of the sender and the receiver, and determine whether or not both the preset number of digits of the phone number of the sender and the receiver are from the same service provider, the preset number of digits represents a network ID.

4. The short message service prompting system of claim 3, wherein the preset number of digits is the first three digits of the phone number.

5. The short message service prompting system of claim 1, wherein when both the sender and the receiver are from different service providers, the short message service prompting module is configured to generate the short message service prompt containing that the sender and the receiver are from different service providers; and when both the sender and the receiver are from the same service provider, the short message service prompting module is configured to generate the short message service prompt containing that the sender and the receiver are from the same service provider.

6. A short message service prompting method adapted for a mobile phone, wherein the mobile phone comprises a display unit and stores a relationship between each service provider and network IDs, the method comprising:
controlling the display unit to display a short message editing interface in response to user input, wherein the short message editing interface comprises a receiver;
receiving a receiver in the short message editing interface in response to user input;
acquiring a phone number of a sender of the mobile phone and a phone number of the receiver and determining whether or not both the sender and the receiver are from the same service provider according to the relationship between each service provider and network IDs; and
generating a short message service prompt and controlling the display unit to display the short message service prompt when both the sender and the receiver are from different service providers or from the same service provider.

7. The short message service prompting method of claim 6, wherein the receiver is represented by a series of digits or a user name.

8. The short message service prompting of method of claim 6, further comprising:
acquiring a preset number of digits of the phone number of the sender and the receiver, and determining whether or not both the preset number of digits of the phone number of the sender and the receiver are from the same service provider, wherein the preset number of digits represents a network ID.

9. The short message service prompting method of claim 8, wherein the preset number of digits is the first three digits of the phone number.

10. The short message service prompting method of claim 6, further comprising:
when both the sender and the receiver are from different service providers, generating the short message service prompt containing that the sender and the receiver are from different service providers; and
when both the sender and the receiver are from the same service provider, generating the short message service prompt containing that the sender and the receiver are from the same service provider.

11. A computer-readable storage medium encoded with a computer program, the program comprising instructions that when executed by one or more computers cause the one or more computers to perform operations for short message service prompting of a mobile phone, the operations comprising:
displaying a short message editing interface in response to user input, wherein the short message editing interface comprises a receiver;
receiving a receiver in the short message editing interface in response to user input;
acquiring a phone number of a sender of the mobile phone and a phone number of the receiver and determining whether or not both the sender and the receiver are from the same service provider according to the relationship between each service provider and network IDs; and
generating a short message service prompt and displaying the short message service prompt when both the sender and the receiver are from different service providers or from the same service provider.

12. The computer-readable storage medium encoded with a computer program of claim 11, wherein the receiver is represented by a series of digits or a user name.

13. The computer-readable storage medium encoded with a computer program of claim 11, the operations further comprising:
acquiring a preset number of digits of the phone number of the sender and the receiver and determining whether or not both the preset number of digits of the phone number of the sender and the receiver are from the same service provider, wherein the preset number of digits represents a network ID.

14. The computer-readable storage medium encoded with a computer program of claim 13, wherein the preset number of digits is the first three digits of the phone number.

15. The computer-readable storage medium encoded with a computer program of claim 11, the operations further comprising:
when both the sender and the receiver are from different service providers, generating the short message service prompt containing that the sender and the receiver are from different service providers; and
when both the sender and the receiver are from the same service provider, generating the short message service prompt containing that the sender and the receiver are from the same service provider.
